(19) United States
(12) Patent Application Publication
(10) Pub. No.: US 2025/0223997 A1
(43) Pub. Date: Jul. 10, 2025

(54) EXTENDABLE AND FLEXIBLE DRIVE SHAFT

(71) Applicant: University of Washington, Seattle, WA (US)

(72) Inventors: Jeffrey Lipton, Honolulu, HI (US); Sawyer Thomas, Seattle, WA (US)

(21) Appl. No.: 18/853,272

(22) PCT Filed: Apr. 6, 2023
(86) PCT No.: PCT/US2023/017706

§ 371 Date: Oct. 1, 2024

Related U.S. Application Data
(60) Provisional application No. 63/328,665, filed on Apr. 7, 2022.

(51) Int. Cl. F16C 1/04

(52) U.S. Cl. CPC F16C 1/04

(57) ABSTRACT

Extendable and flexible drive shaft members and drive shaft assemblies include circumferentially distributed anisotropic mechanisms configured to accommodate extension and flexure. A drive shaft member includes anisotropic mechanisms that are interconnected and distributed circumferentially around a longitudinal centerline of the drive shaft member. Each of the anisotropic mechanisms is configured to accommodate extension of the anisotropic mechanism parallel to the longitudinal centerline. The anisotropic mechanisms combine to transmit a torque along the longitudinal centerline.

### CROSS-REFERENCES TO RELATED APPLICATIONS

This application claims the benefit of U.S. Provisional Application No. 63/328,665 filed Apr. 7, 2022, the entire contents of which are hereby incorporated for all purposes in their entirety.

### STATEMENT AS TO RIGHTS TO INVENTIONS MADE UNDER FEDERALLY SPONSORED RESEARCH AND DEVELOPMENT

This invention was made with government support under Grant No. 13232772, awarded by the Office of Naval Research—VA. The government has certain rights in the invention.

### BACKGROUND

Drive shafts for transmitting mechanical torque and rotation are used in a wide variety of applications including vehicles and machines. In many existing applications, additional mechanical components such as universal joints, jaw couplings, flex shafts, or rag joints are employed to accommodate changes in alignment and/or distance between the driving and driven components. In some applications, multiple drive shafts are employed.

### BRIEF SUMMARY

The following presents a simplified summary of some embodiments of the invention to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments described herein are directed to flexible and extendable drive shafts for torque and rotational motion transmission. In many embodiments, a flexible and extendable drive shaft employs a drive shaft member that includes anisotropic mechanisms that are interconnected and distributed circumferentially around a longitudinal centerline of the drive shaft member. Each of the anisotropic mechanisms is configured to accommodate extension of the anisotropic mechanism parallel to the longitudinal centerline. The anisotropic mechanisms combine to transmit a torque along the longitudinal centerline. In many embodiments, the anisotropic mechanisms are implemented as compliant mechanisms that approximate a respective straight line mechanism (SLM) configured to constrain a point in the SLM to move substantially parallel to the longitudinal centerline of the drive shaft member. Due to the accommodated extension, the anisotropic mechanisms accommodate increased extension and flexure of the drive shaft member relative to comparable existing drive shaft members that do not employ distributed anisotropic mechanisms. In some embodiments, a drive shaft assembly includes two or more concentrically nested drive shaft members that employ distributed anisotropic mechanisms. In such embodiments, the drive shaft assembly can independently transmit two or more torques while also accommodating increased extension and flexure relative to comparable existing drive shaft assemblies that do not employ distributed anisotropic mechanisms.

Thus, in one aspect, a drive shaft member includes anisotropic mechanisms that are interconnected and distributed circumferentially around a longitudinal centerline of the drive shaft member. Each of the anisotropic mechanisms is configured to accommodate extension of the anisotropic mechanism parallel to the longitudinal centerline. The anisotropic mechanisms combine to transmit a torque along the longitudinal centerline. In many embodiments, the anisotropic mechanisms are configured as compliant mechanisms that approximate straight line mechanisms.

In another aspect, a drive shaft assembly includes a first drive shaft member and a second drive shaft member concentric with the first drive shaft member and extending through the first drive shaft member. The first drive shaft member includes first anisotropic mechanisms that are interconnected and distributed circumferentially around a longitudinal centerline of the drive shaft assembly. Each of the first anisotropic mechanisms is configured to accommodate extension of the first anisotropic mechanism parallel to the longitudinal centerline. The first anisotropic mechanisms are configured to combine to transmit a first torque along the longitudinal centerline. The second drive shaft member includes second anisotropic mechanisms that are interconnected and distributed circumferentially around the longitudinal centerline. Each of the second anisotropic mechanisms is configured to accommodate extension of the second anisotropic mechanism parallel to the longitudinal centerline. The second anisotropic mechanisms are configured to combine to transmit a second torque along the longitudinal centerline independent of the first torque. In many embodiments, the first and second anisotropic mechanisms are configured as compliant mechanisms that approximate straight line mechanisms.

For a fuller understanding of the nature and advantages of the present invention, reference should be made to the ensuing detailed description and accompanying drawings.

### BRIEF DESCRIPTION OF THE DRAWINGS

FIG. 1 shows a prototype extendable and flexible drive shaft, in accordance with embodiments.

FIG. 2 shows the prototype extendable and flexible drive shaft of FIG. 1 in an extended state.

FIG. 3 shows the prototype extendable and flexible drive shaft of FIG. 1 in a flexed state.

FIG. 4A, FIG. 4B, FIG. 4C, FIG. 4D, and FIG. 4E illustrates example straight line mechanisms (SLMs) and corresponding compliant mechanism implementations, which can be employed in an extendable and flexible drive shaft member, in accordance with embodiments.

FIG. 5 illustrates a compound Watt's SLM mechanism comprising two connected Watts SLMs, in accordance with embodiments.

FIG. 6 and FIG. 7 show a compound Watt's compliant mechanism, in accordance with embodiments.

FIG. 8 shows a three-dimensional plot of the design space of the compound Watt's compliant mechanism of FIG. 6 and FIG. 7.

FIG. 9 shows a plot of torsional stiffness as a function of extension of the prototype extendable and flexible drive shaft member of FIG. 1.

FIG. 10 shows a plot of reaction torque at different degrees of rotation as a function of extension for the prototype extendable and flexible drive shaft member of FIG. 1.

FIG. 11 shows plots of torsional stiffness as a function of extension for prototype extendable and flexible drive shaft members made from 2 mm and 3 mm thick cylinders.

FIG. 12, FIG. 13, and FIG. 14 show views of the extendable and flexible drive shaft member of the prototype drive shaft of FIG. 1.

FIG. 15 shows extendable and flexible drive shaft members with different lengths, in accordance with embodiments.

FIG. 16 illustrates a hexagonal drive shaft member made from interconnected flat panels that include Peaucellier-Lipkin compliant mechanisms, in accordance with embodiments.

FIG. 17 illustrates a tiled assembly comprising an arrangement of compound XBob compliant mechanisms that can be employed in an extendable and flexible drive shaft member, in accordance with embodiments.

FIG. 18 illustrates another tiled assembly comprising an arrangement of compound XBob compliant mechanisms that can be employed in an extendable and flexible drive shaft member, in accordance with embodiments.

FIG. 19 illustrates another tiled assembly comprising an arrangement of compound XBob compliant mechanisms that can be employed in an extendable and flexible drive shaft member, in accordance with embodiments.

FIG. 20 illustrates another tiled assembly comprising an arrangement of compound XBob compliant mechanisms that can be employed in an extendable and flexible drive shaft member, in accordance with embodiments.

FIG. 21 shows a drive shaft assembly that includes nested extendable and flexible drive shaft members, in accordance with embodiments.

FIG. 22 shows a cross-sectional view of a drive shaft assembly that includes nested extendable and flexible drive shaft members, in accordance with embodiments.

### DETAILED DESCRIPTION

In the description herein, various embodiments are described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

### Flexible and Extendable Drive Shaft Members

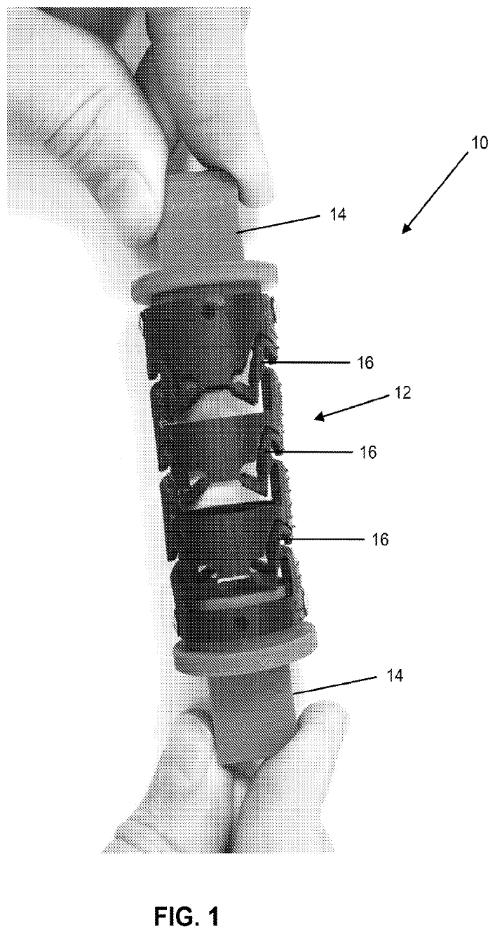

Turning now to the drawing figures, in which similar reference numbers refer to similar elements, FIG. 1 shows a prototype extendable and flexible drive shaft 10, in accordance with embodiments. The prototype extendable and flexible drive shaft 10 includes an extendable and flexible drive shaft member 12 and end fittings 14. The extendable and flexible drive shaft member 12 is configured to include anisotropic mechanisms 16 that are interconnected and distributed circumferentially around a longitudinal centerline of the drive shaft member 12. Each of the anisotropic mechanisms 16 is configured to accommodate extension of the anisotropic mechanism 16 parallel to the longitudinal centerline. The anisotropic mechanisms 16 combine to transmit a torque along the longitudinal centerline. In the illustrated embodiment, the anisotropic mechanisms 16 are configured as compound Watt's compliant mechanisms, which are configured to approximate compound Watt's straight line mechanisms (SLMs) configured to constrain a respective point in each of the anisotropic mechanisms 16 to move substantially parallel to the longitudinal centerline of the drive shaft member 12. FIG. 1 shows the drive shaft member 12 in a non-extended and non-flexed state.

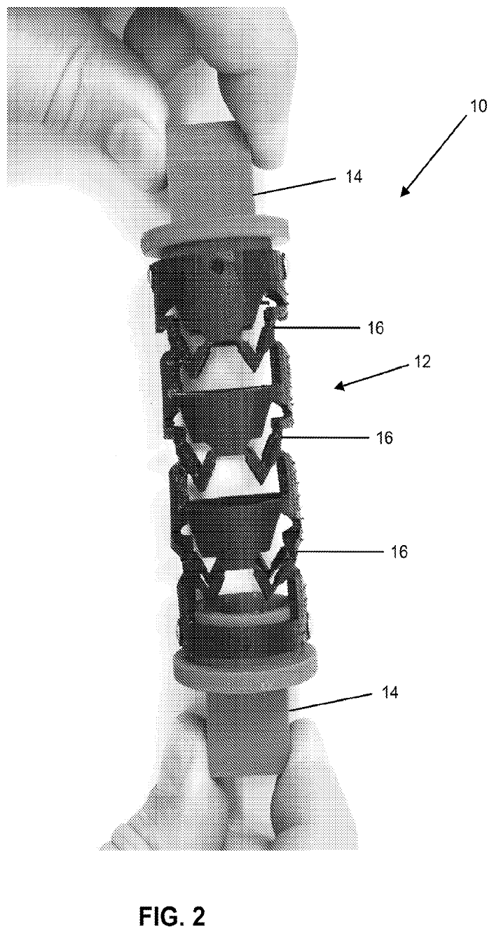

FIG. 2 shows the prototype drive shaft 10 with the drive shaft member 12 in an extended state. In the illustrated extended state, the drive shaft member 12 is extended to approximately 1.2 times the length of the drive shaft member 12 in the non-extended and non-flexed state shown in FIG. 1. The extension is accommodated by the anisotropic mechanisms 16, which are configured to provide extensional compliance to the drive shaft member 12 as described herein.

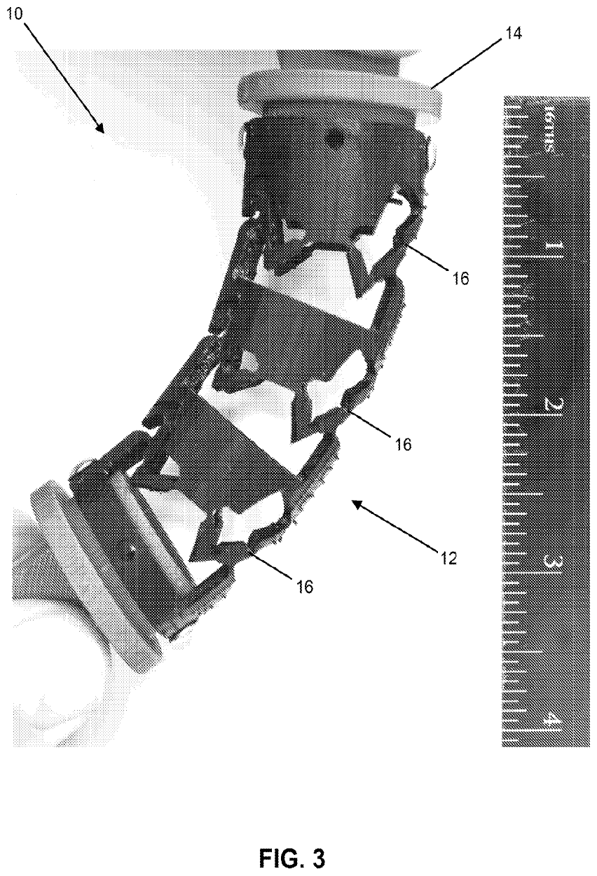

FIG. 3 shows the prototype drive shaft 10 in a flexed state in which the drive shaft member 12 extends between the end fittings 14 along a curved centerline. The anisotropic mechanisms 16 accommodate the flexed state of the drive shaft member 12 via the anisotropic mechanisms 16 being circumferentially and longitudinally distributed in the drive shaft member 12. Cross-sectional bending of the drive shaft member 12 produces longitudinal extension and contraction of the drive shaft member 12 that is a function of a positional offset from a resulting bending neutral axis. The circumferentially and longitudinally distributed anisotropic mechanisms 16 are configured to accommodate the longitudinal extension and contraction of the drive shaft member 12 via the extensional compliance that the anisotropic mechanisms 16 provide to the drive shaft member 12.

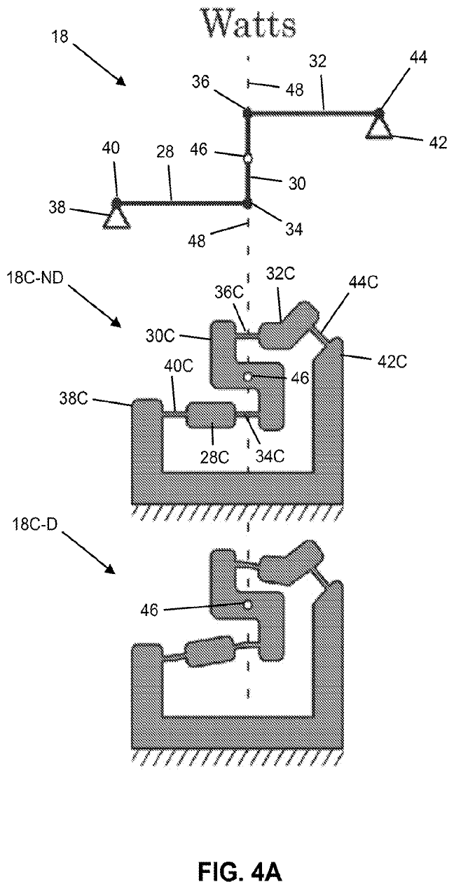

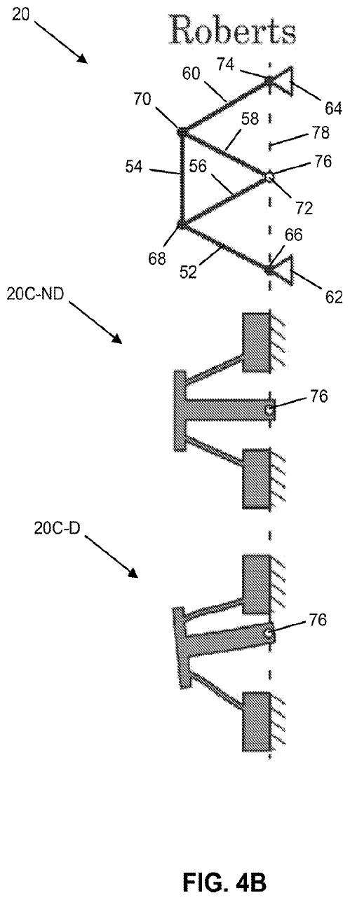

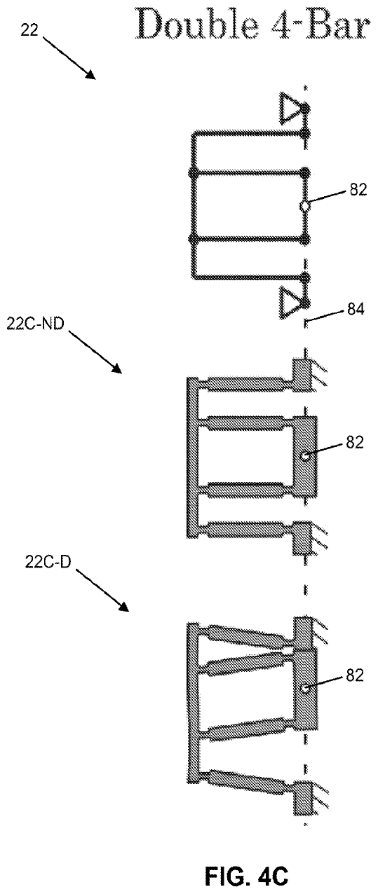

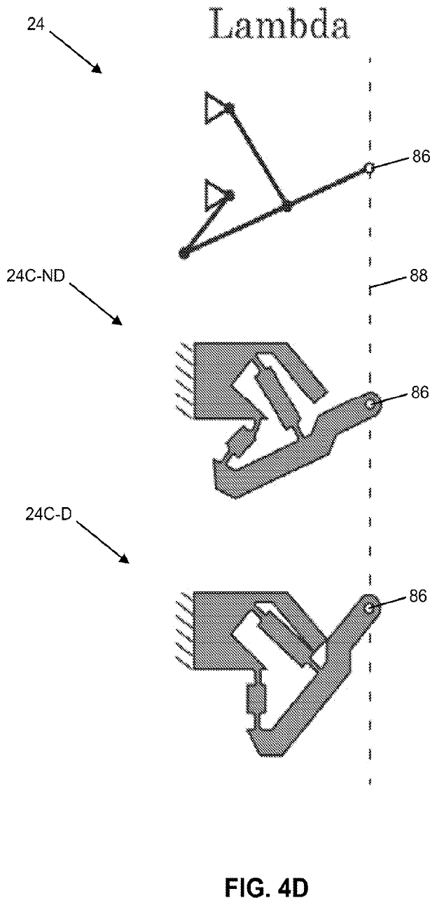

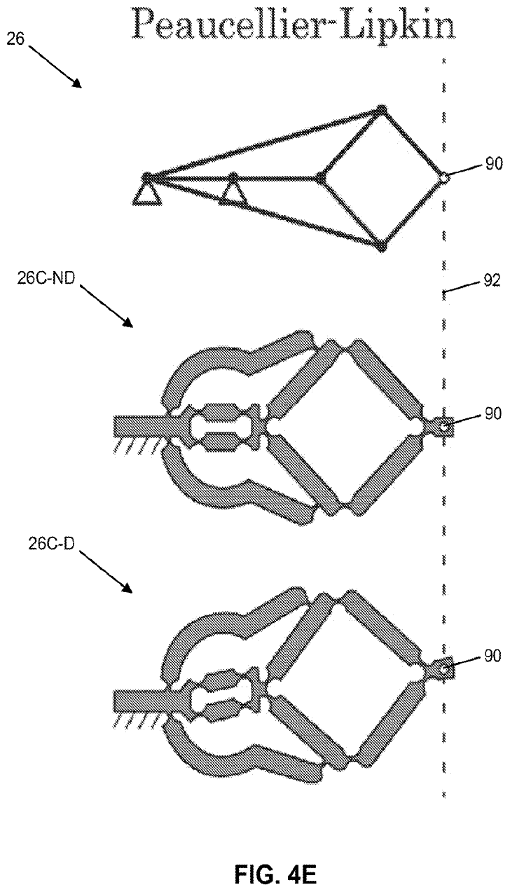

FIG. 4A, FIG. 4B, FIG. 4C, FIG. 4D, and FIG. 4E illustrate example straight line mechanisms (SLMs) and corresponding compliant mechanisms implementations, which can be employed in an extendable and flexible drive shaft member, in accordance with embodiments. The illustrated SLMs include a Watt's SLM 18, a Robert's SLM 20, a Double Four-Bar SLM 22, a Lambda SLM 24, and a Peaucellier-Lipkin SLM 26.

The Watt's SLM 18 (shown in FIG. 4A) includes links 28, 30, 32. The link 30 is connected to and between the links 28, 32 via pinned joints 34, 36. The link 28 is connected to a fixed support 38 via a pinned joint 40. The link 32 is connected to a fixed support 42 via a pinned joint 44. The Watt's SLM 18 is configured to restrain a reference point 46 on the second link 30 to a straight line movement on a straight line 48. A Watt's compliant mechanism 18C that approximates the Watt's SLM 18 is shown in an undeformed state 18C-ND and a deformed state 18C-D. A compliant mechanism is a flexible mechanism configured to transmit force and motion via elastic body deformation. The Watt's compliant mechanism 18C includes links 28C, 30C, 32C and fixed supports 38C, 42C. The links 28C, 30C, 32C correspond to the links 28, 30, 32, respectively. The fixed supports 38C, 42C correspond to the fixed support 38, 40, respectively. The Watt's compliant mechanism 18C includes flexible connection links 34C, 36C, 40C, 44C. The flexible connection link 34C connects links 28C, 30C and is configured to approximate the pinned joint 34. The flexible connection link 36C connects links 30C, 32C and is configured to approximate the pinned joint 36. The flexible connection link 40C connects link 28C to the fixed support 38C and is configured to approximate the pinned joint 40. The flexible connection link 44C connects link 32C to the fixed support 42C and is configured to approximate the pinned joint 44. Each of the flexible connection links 34C, 36C, 40C, 44C has a substantially reduced width relative to the links 28C, 30C, 32C to concentrate bending compliance of the Watt's compliant mechanism 18C in the flexible connection links 34C, 36C, 40C, 44C to approximate the pinned joints 34, 36, 40, 44 of the Watt's SLM 18. As shown, the reference point 46 in the Watt's compliant mechanism 18C translates along the straight line 48 between the undeformed state 18C-ND and the deformed state 18C-D.

The Robert's SLM 20 (shown in FIG. 4B) includes links 52, 54, 56, 58, 60, fixed supports 62, 64, and pinned joints 66, 68, 70, 72, 74 via which the links 52, 54, 56, 58, 60 and the fixed support 62, 64 are connected. The Robert's SLM 20 is configured to restrain a reference point 76 to a straight line movement on a straight line 78. A Robert's compliant mechanism 20C that approximates the Robert's SLM 20 is shown in an undeformed state 20C-ND and a deformed state 20C-D.

The Double Four-Bar SLM 22 (shown in FIG. 4C) is configured to restrain a reference point 82 to a straight line movement on a straight line 84. A Double Four-Bar compliant mechanism 22C that approximates the Double Four-Bar SLM 22 is shown in an undeformed state 22C-ND and a deformed state 22C-D.

The Lambda SLM 24 (shown in FIG. 4D) is configured to restrain a reference point 86 to a straight line movement on a straight line 88. A Lambda compliant mechanism 24C that approximates the Lambda SLM 24 is shown in an undeformed state 24C-ND and a deformed state 24C-D.

The Peaucellier-Lipkin SLM 26 (shown in FIG. 4E) is configured to restrain a reference point 90 to a straight line movement on a straight line 92. A Peaucellier-Lipkin compliant mechanism 26C that approximates the Peaucellier-Lipkin SLM 26 is shown in an undeformed state 26C-ND and a deformed state 26C-D.

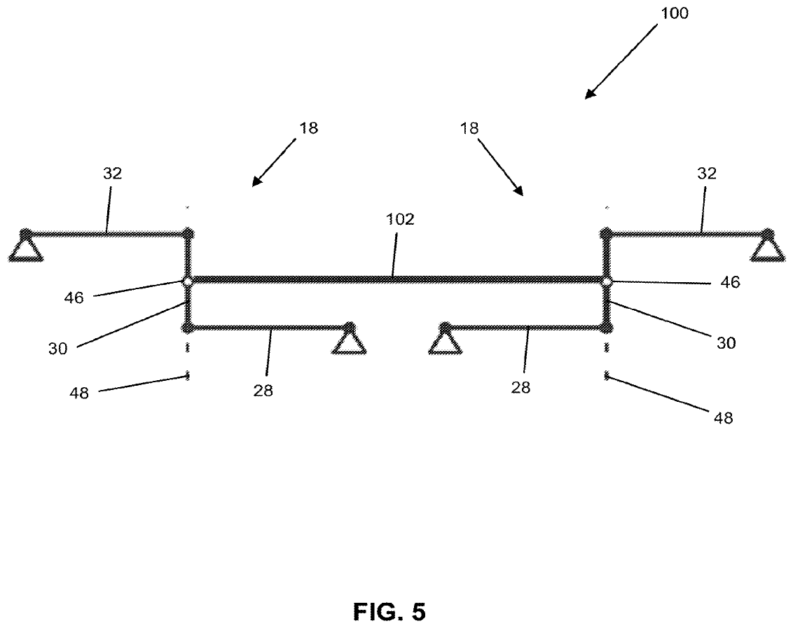

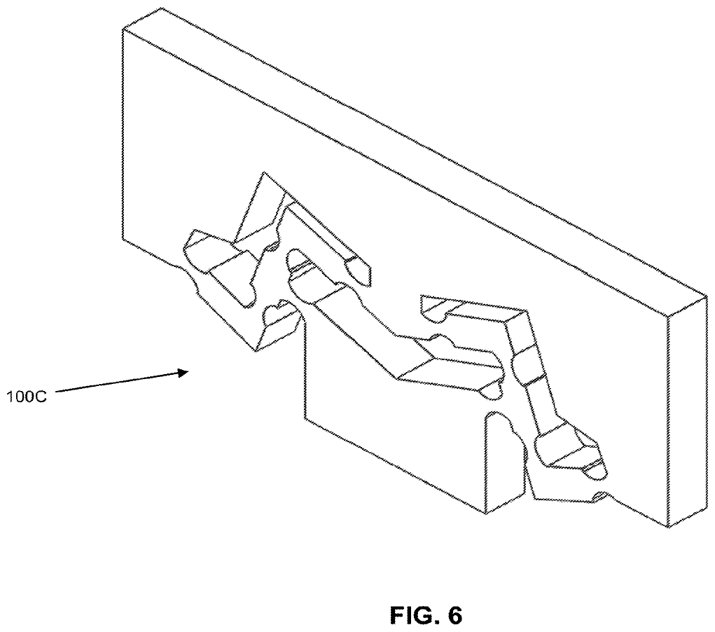

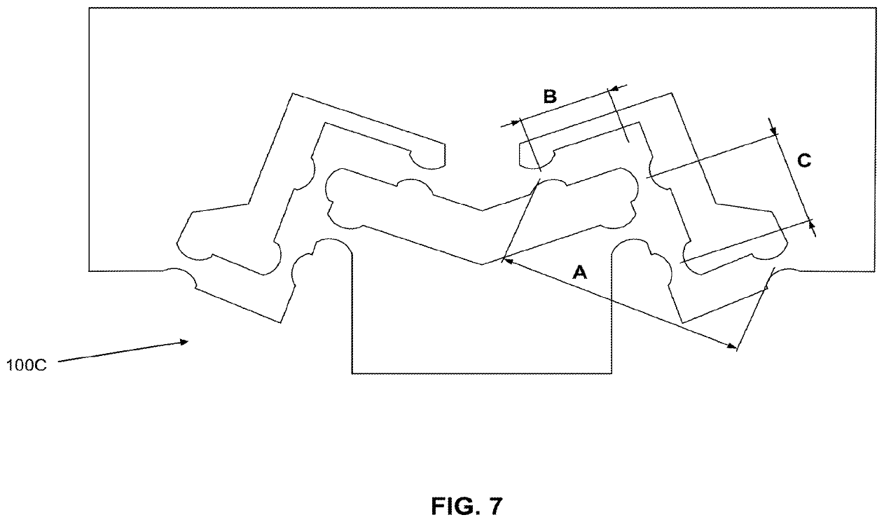

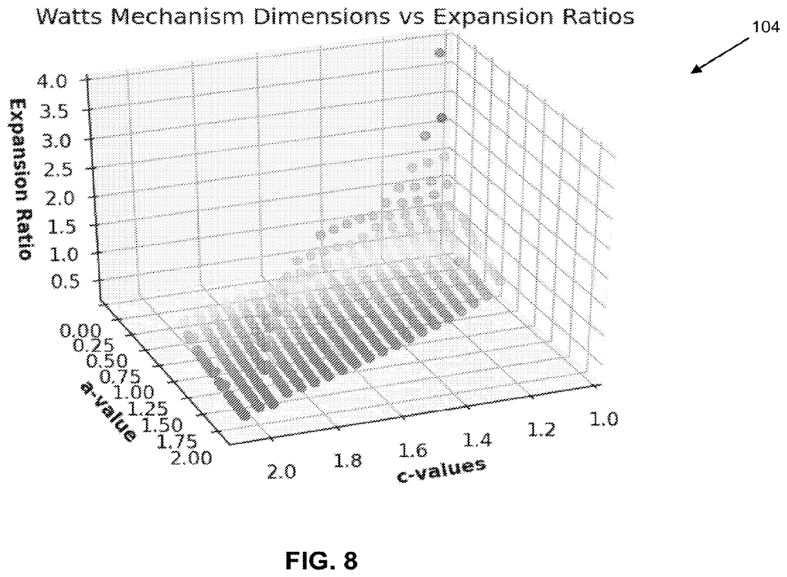

FIG. 5 illustrates a compound Watt's SLM mechanism 100 comprising two connected Watts SLMs 18, in accordance with embodiments. The compound Watt's SLM mechanism 100 includes a connection link 102 connected between the links 30 at the reference points 46. The compound SLM mechanism 100 constrains movement of the connection link 102 to translation along the straight lines 48. FIG. 6 shows an embodiment of a compound Watt's compliant mechanism 100C that approximates the compound Watt's SLM 100. FIG. 7 shows reference dimensions of the compound Watt's compliant mechanism 100C. FIG. 8 shows a three-dimensional plot 104 of expansion ratio of the compound Watt's compliant mechanism 100C as a function of the a-values and c-values as defined in FIG. 7. The plot 104 can be used to configure a suitable embodiment of the compound Watt's compliant mechanism 100C for use in an expandable and flexible drive shaft member to accommodate desired elongation and bending flexibility.

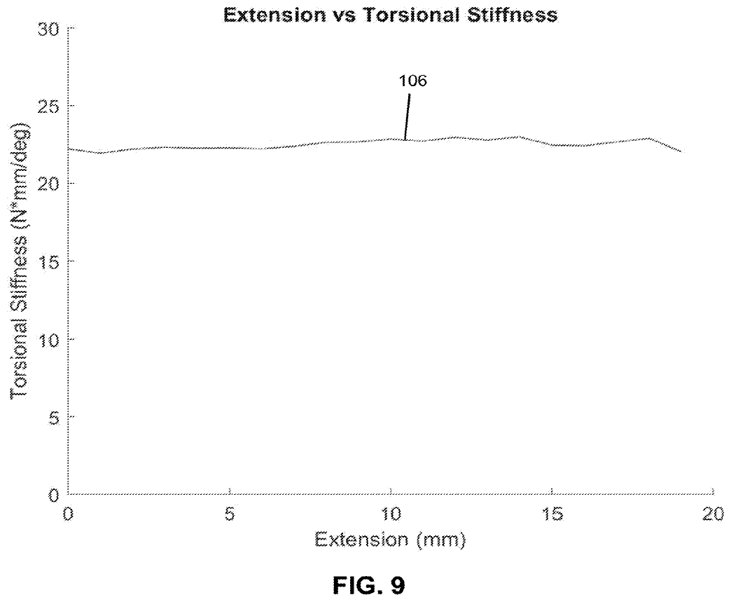

FIG. 9 shows a plot 106 of torsional stiffness of the extendable and flexible drive shaft member 12 as a function of extension length. As can be seen, the torsional stiffness of the drive shaft member 12 does not vary substantially as a result of extension of the drive shaft member 12. The tested geometry included three in-line Watt's mechanisms wrapped to form a cylinder with 2× radial symmetry. The shaft in the tested geometry was 70 mm in length with a 30 mm outer diameter and a 26 mm inner diameter. The flexure thickness in the tested geometry was 0.85 mm and the flexure length was 2 mm.

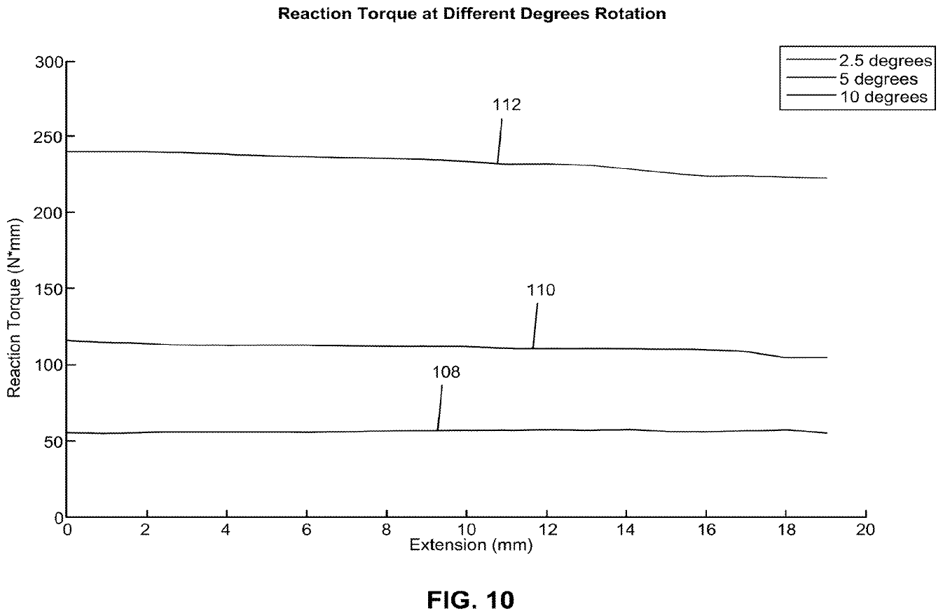

FIG. 10 shows plots 108, 110, 112 of the reaction torque at a fixed end of the member resulting from different set angular displacements at the opposite end of the member, as a function of extension length. As shown, the torsional stiffness of the drive shaft member 12 does not vary substantially as a result of extension of the drive shaft member 12. Plot 108 shows the reaction torque at 2.5 degrees of rotation. Plot 110 shows the reaction torque at 5degrees of rotation. Plot 112 shows the reaction torque at 10 degrees of rotation. The tested geometry included three in-line Watt's mechanisms wrapped to form a cylinder with 2× radial symmetry. The shaft in the tested geometry was 70 mm in length with a 30 mm outer diameter and a 26 mm inner diameter. The flexure thickness in the tested geometry was 0.85mm and the flexure length was 2 mm.

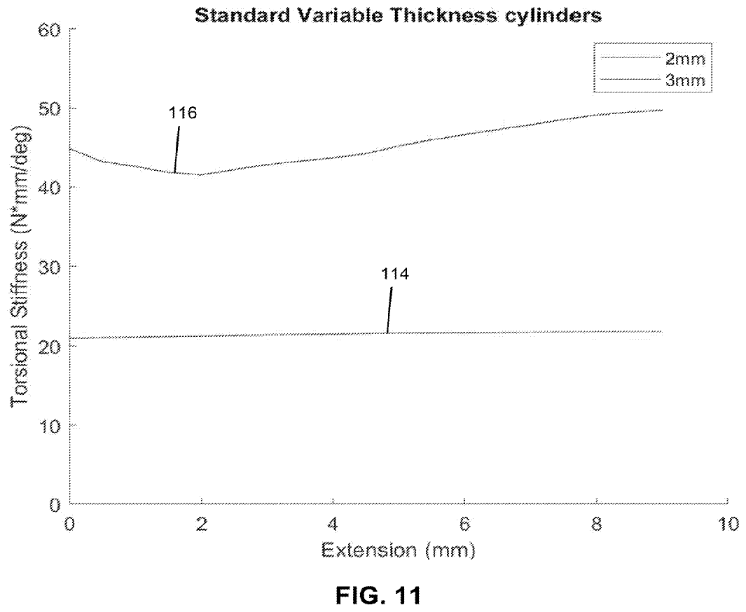

FIG. 11 shows plots 114, 116 of torsional stiffness of prototypes of the extendable and flexible drive shaft member 12 made from 2 mm and 3 mm thick cylinders as a function of extension. Plot 114 shows the torsional stiffness for the drive shaft member 12 made from a 2 mm thick cylinder. As shown, the torsional stiffness in plot 114 does not vary substantially as a result of extension of the drive shaft member 12 made from a 2 mm thick cylinder. In contrast, the torsional stiffness in plot 114 does vary to a noticeable extent as a result of extension of the drive shaft member 12 made from a 3 mm thick cylinder. Each of the two tested geometries included three in-line Watt's mechanisms wrapped to form a cylinder with 2× radial symmetry. The shaft in each of the two tested geometries was 70 mm in length with a 30 mm outer diameter and a 26 mm inner diameter. The flexure thickness in each of the two tested geometries was 0.85 mm and the flexure length was 2 mm.

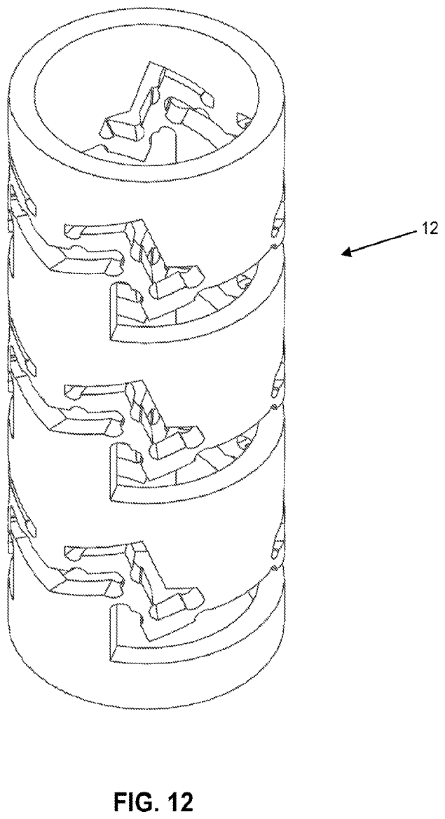

FIG. 12, FIG. 13, and FIG. 14 show views of the extendable and flexible drive shaft member 12. As shown, the drive shaft member 12 includes 12 compound Watt's compliant mechanism 100C distributed circumferentially and longitudinally in three annular bands of four of the compound Watt's compliant mechanism 100C.

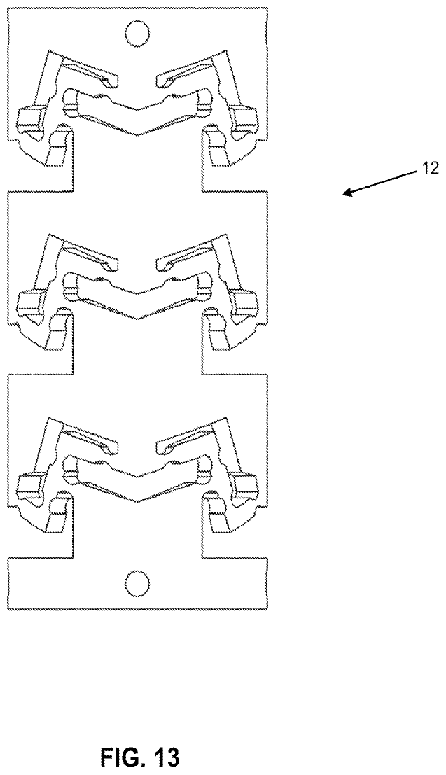

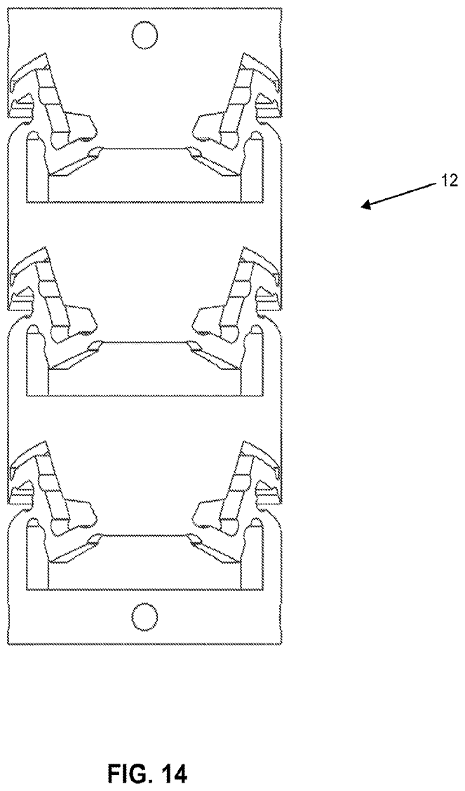

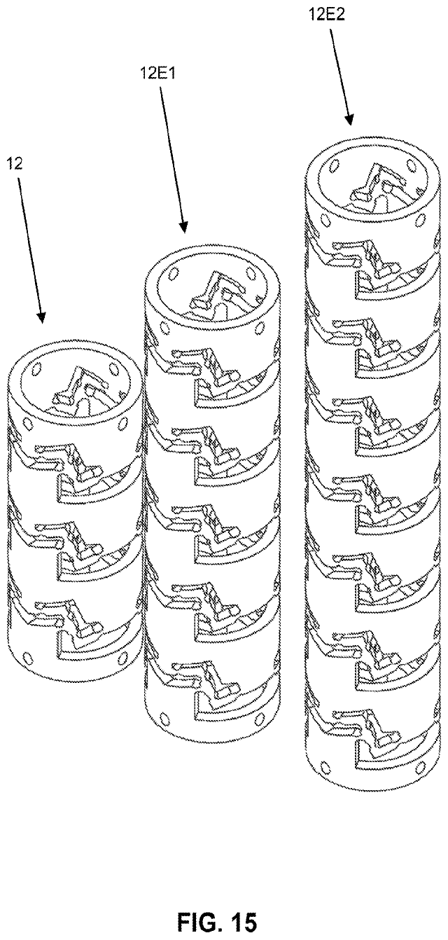

The drive shaft member 12 can have any suitable length and incorporate any suitable number of suitable anisotropic mechanisms that are distributed circumferentially and longitudinally within the drive shaft member 12. For example, FIG. 15 shows the drive shaft member 12 next to an extendable and flexible drive shaft member 12E1 and an extendable and flexible drive shaft member 12E2. The drive shaft members 12E1, 12E2 are configured similar to the drive shaft member 12 except for being longer and incorporating more annular bands of the compound Watt's compliant mechanisms 100C. The drive shaft member 12E1 has 20 of the compound Watt's compliant mechanisms 100C, which are distributed in five bands of four of the compound Watt's compliant mechanisms 100C. The drive shaft member 12E2 has 28 of the compound Watt's compliant mechanisms 100C, which are distributed in seven bands of four of the compound Watt's compliant mechanisms 100C.

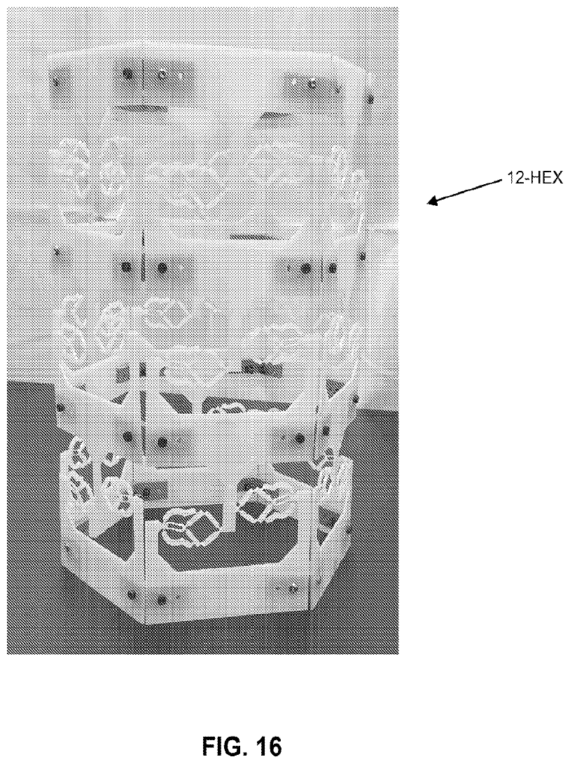

A flexible and extendable drive shaft member can include any suitable anisotropic mechanism and have any suitable configuration. For example, FIG. 16 illustrates a hexagonal drive shaft member 12-HEX made from interconnected flat panels that include Peaucellier-Lipkin compliant mechanisms, in accordance with embodiments.

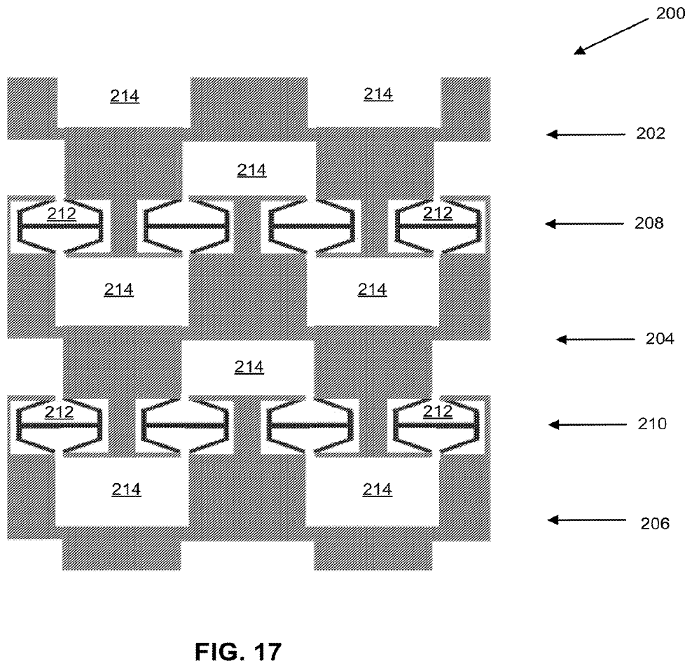

FIG. 17 illustrates a tiled assembly 200 for a flexible and extendable drive shaft member. In the illustrated embodiment, the tiled assembly 200 includes three annular support bands 204, 206, 208 and two annular bands 208, 210 of connected XBob compliant mechanisms 212. The XBob compliant mechanisms 212 are circumferentially arranged and oriented in each of the two annular bands 208, 210. Each of the three annular support bands 206, 208, 210 includes annularly distributed openings 214 sized to accommodate relative longitudinal movement between the annular support bands 204, 206, 208 to accommodate extension and/or flexure of a flexible and extendable drive shaft member that incorporates the tiled assembly 200.

FIG. 18 illustrates a tiled assembly 300 for a flexible and extendable drive shaft member. In the illustrated embodiment, the tiled assembly 300 includes support members 302 and three annular bands 304, 306, 308 of connected XBob compliant mechanisms 212. The XBob compliant mechanisms 212 are circumferentially arranged and oriented in each of the three annular bands 304, 306, 308. Each of the support members 302 includes openings sized to accommodate relative longitudinal movement between the support members 302 bands to accommodate extension and/or flexure of a flexible and extendable drive shaft member that incorporates the tiled assembly 300.

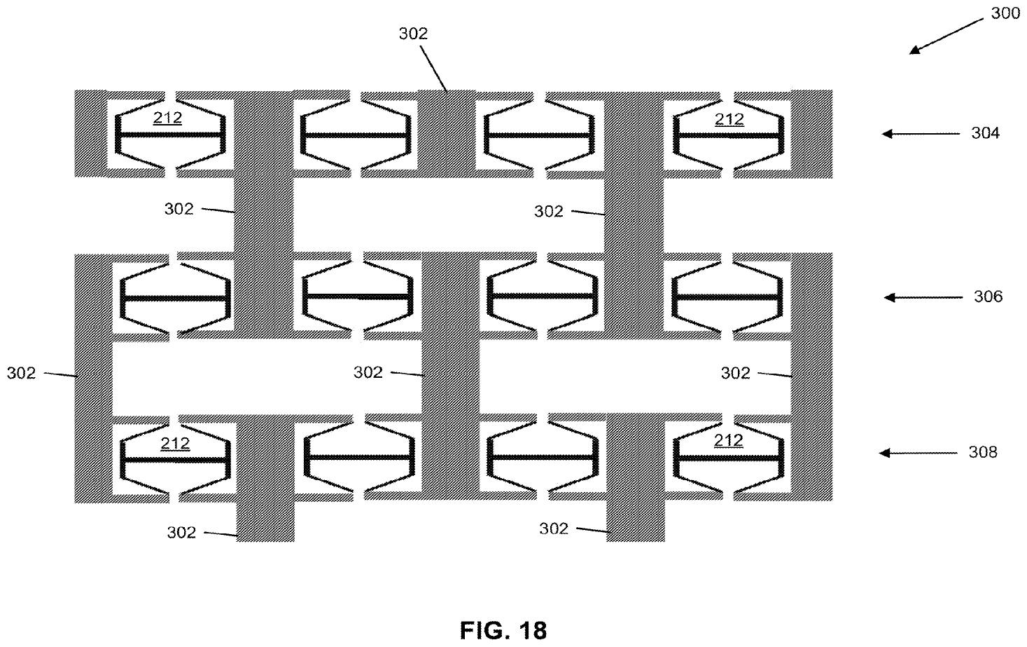

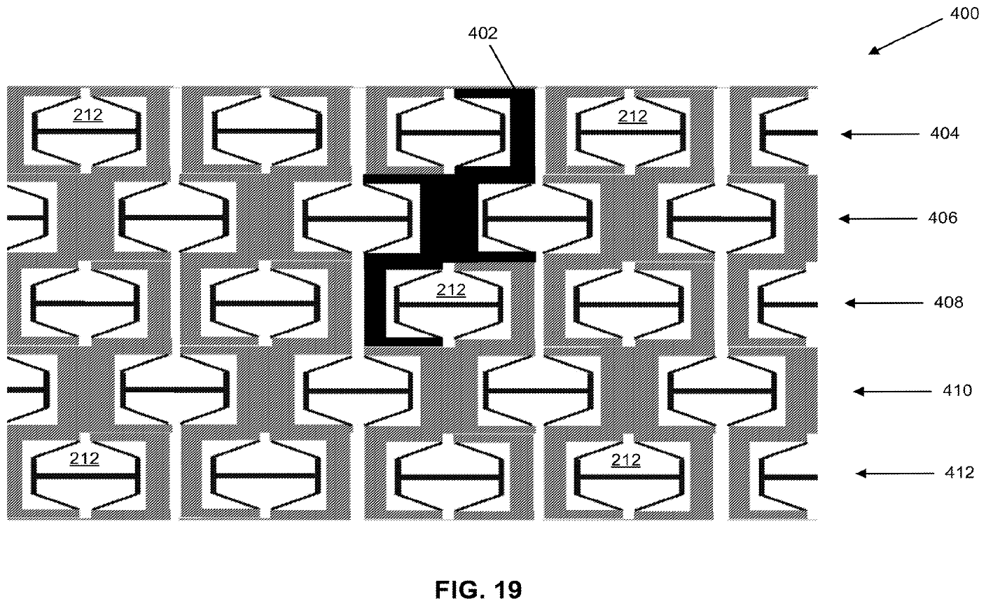

FIG. 19 illustrates another tiled assembly 400 for a flexible and extendable drive shaft member. In the illustrated embodiment, the tiled assembly 400 includes support members 402 and five annular bands 404, 406, 408, 410, 412 of connected XBob compliant mechanisms 212. The XBob compliant mechanisms 212 are circumferentially arranged and oriented in each of the five annular bands 404, 406, 408, 410, 412. Each of the support members 402 includes four openings with each opening sized to accommodate one side of one of the XBob compliant mechanisms 212. Extension of the drive shaft member produces separation between longitudinally adjacent instances of the support members 402. The tile assembly 400 can be used to produce a drive shaft member with greater compliance in extension due to the greater longitudinal density of the Xbob compliant mechanisms 212 and reduced compliance in compression due to the resulting longitudinal columns of the support members 402 relative to the tiled assemblies 200, 300.

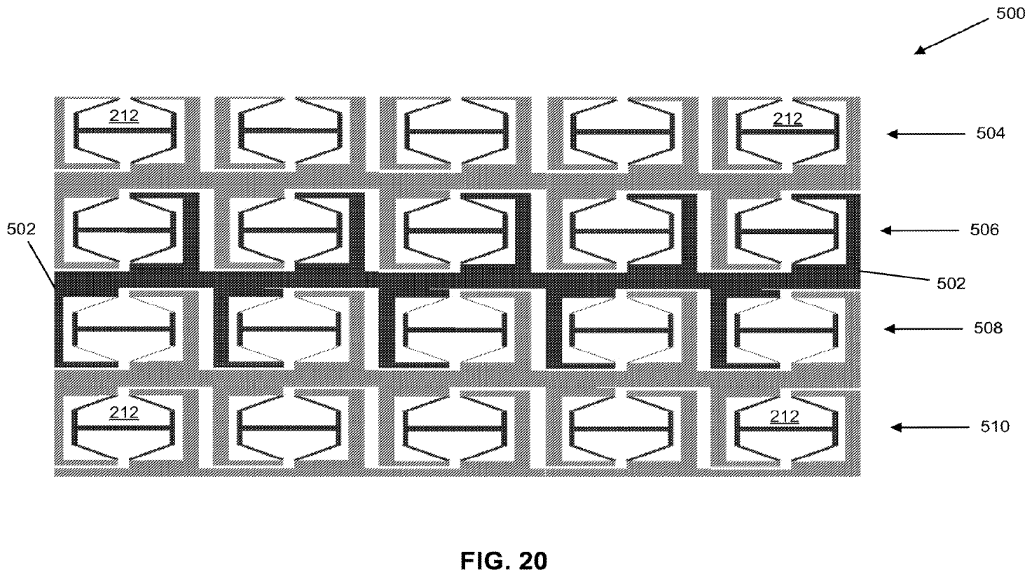

FIG. 20 illustrates another tiled assembly 500 for a flexible and extendable drive shaft member. In the illustrated embodiment, the tiled assembly 500 includes annular support members 502 and four annular bands 504, 506, 508, 510 of connected XBob compliant mechanisms 212. The XBob compliant mechanisms 212 are circumferentially arranged and oriented in each of the four annular bands 504, 506, 508, 510. Each of the annular support members 502 includes openings with each opening sized to accommodate one side of one of the XBob compliant mechanisms 212. Extension of the drive shaft member produces separation between longitudinally adjacent instances of the annular support members 502. The tiled assembly 500 can be used to produce a drive shaft member with greater compliance in extension due to the greater longitudinal density of the Xbob compliant mechanisms 212 and reduced compliance in compression due to the resulting stacking of the annular support members 502 relative to the tiled assemblies 200, 300. The annular support members 502 stiffen the drive shaft member against change in cross-sectional shape relative to the tiled assembly 400 in which the support members 402 are not directly connected in the circumferential direction of the drive shaft member.

In many embodiments, a flexible and extendable drive shaft member includes anisotropic mechanisms that are interconnected and distributed circumferentially around a longitudinal centerline of the drive shaft member. Each of the anisotropic mechanisms is configured to accommodate extension of the anisotropic mechanism parallel to the longitudinal centerline. The anisotropic mechanisms combine to transmit a torque along the longitudinal centerline.

In many embodiments of the flexible and extendable drive shaft member, the anisotropic mechanisms include or are configured as compliant mechanisms. Each of the compliant mechanisms can be configured to approximate a straight line mechanism (SLM) configured to constrain a point in the SLM to move substantially parallel to the longitudinal centerline. In some embodiments of the flexible and extendable drive shaft member, each of one or more of the compliant mechanisms is configured to approximate a Watt's SLM. In some embodiments of the flexible and extendable drive shaft member, each of one or more of the compliant mechanisms is configured to approximate a Robert's mechanism, a Double 4-Bar mechanism, a Lambda mechanism, or a Peaucellier-Lipkin mechanism. In many embodiments of the flexible and extendable drive shaft member, each of the compliant mechanisms is monolithic. In some embodiments of the flexible and extendable drive shaft member, each of the compliant mechanisms is formed of one or more polymers. In some embodiments, the flexible and extendable drive shaft member is a monolithic structure that includes the compliant mechanisms. In some embodiments, the monolithic drive shaft member is formed of one or more polymers. In some embodiments, the monolithic drive shaft member has a constant thickness perpendicular to the longitudinal centerline.

The flexible and extendable drive shaft member can have any suitable configuration. For example, in some embodiment, the flexible and extendable drive shaft member includes annular rings, wherein each of the annular rings is formed from a respective subset of the anisotropic mechanisms. In many embodiments of the flexible and extendable drive shaft member, the anisotropic mechanisms are arranged to approximate a cylinder. In some embodiments, the flexible and extendable drive shaft member includes flat panel portions that extend parallel to the longitudinal centerline. Each of the flat panel portion can include a respective subset of the anisotropic mechanisms. The flat panel portions can be arranged so that the drive shaft member has a cross section with a polygonal exterior perimeter. The drive shaft member can include attachment members via which the flat panel portions are connected.

The flexible and extendable drive shaft member can be formed from any suitable material using any suitable approach. For example, the flexible and extendable drive shaft member can be formed by removing material from a cylinder of a suitable material and thickness to form compliant mechanisms that form the anisotropic mechanisms. The flexible and extendable drive shaft member can be formed using a suitable additive manufacturing process, such as three-dimensional printing. The flexible and extendable drive shaft member can be formed from any suitable material (e.g., a suitable polymer, a nickel titanium alloy (nitinol)).

The anisotropic mechanisms can be arranged in any suitable manner. For example, the anisotropic mechanisms can be arranged in a pattern with mirror symmetries. The anisotropic mechanisms can be arranged in a pattern with rotational symmetries. The anisotropic mechanisms can be arranged in a pattern with mirror symmetries and rotational symmetries.

Drive Shaft Assemblies with Nested Flexible and Extendable Drive Shaft Members

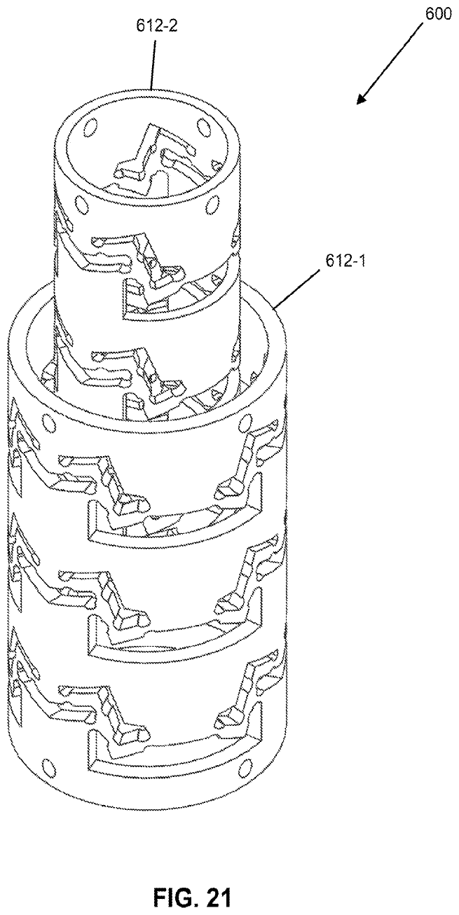

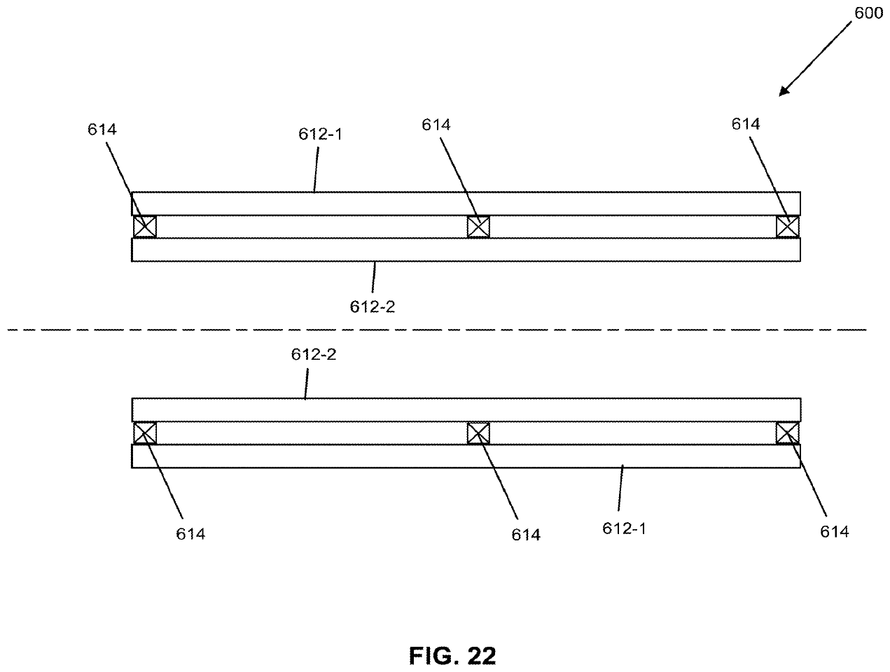

FIG. 21 shows a drive shaft assembly 600 that includes nested extendable and flexible drive shaft members 612-1, 612-2, in accordance with embodiments. FIG. 22 shows a cross-sectional view of the drive shaft assembly 600. Each of the drive shaft members 612-1, 612-2 can be configured similar to the drive shaft member 12 and incorporate any suitable anisotropic mechanism and any suitable distribution of the anisotropic mechanisms, such as those described herein. In the illustrated embodiment, each of the drive shaft members 612-1, 612-2 incorporate annular bands of four of the compound Watt's compliant mechanisms 100C. In the illustrated embodiment, the drive shaft assembly 600 includes radial bearings 614 disposed in an annular space between the drive shaft members 612-1, 612-2. The radial bearings 614 are configured to maintain a suitable annular gap between the drive shaft members 612-1, 612-2 and accommodate relative rotation between the drive shaft members 612-1, 612-2 to accommodate independent transmission of rotary movement and torque via each of the drive shaft members 612-1, 212-2.

In many embodiments, a flexible and extendable drive shaft assembly includes a first drive shaft member and a second drive shaft member that is concentric with the first drive shaft member and extends through the first drive shaft member. The first drive shaft member includes first anisotropic mechanisms that are interconnected and distributed circumferentially around a longitudinal centerline of the drive shaft assembly. Each of the first anisotropic mechanisms is configured to accommodate extension of the first anisotropic mechanism parallel to the longitudinal centerline. The first anisotropic mechanisms are configured to combine to transmit a first torque along the longitudinal centerline. The second drive shaft member includes second anisotropic mechanisms that are interconnected and distributed circumferentially around the longitudinal centerline. Each of the second anisotropic mechanisms is configured to accommodate extension of the second anisotropic mechanism parallel to the longitudinal centerline. The second anisotropic mechanisms are configured to combine to transmit a second torque along the longitudinal centerline independent of the first torque. In some embodiments, the drive shaft assembly further includes one or more bearings configured to separate the first drive shaft member and the second drive shaft member and accommodate relative rotation between the first drive shaft member and the second drive shaft member. In some embodiments, the one or more bearings include one or more rotary bearings and/or one or more sliding bearings having a coefficient of friction of 0.1 or less. The first and second drive shaft members can have any suitable configuration, such as the extendable and flexible drive shaft member configurations described herein.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A drive shaft member comprising:
anisotropic mechanisms that are interconnected and distributed circumferentially around a longitudinal centerline of the drive shaft member, wherein each of the anisotropic mechanisms is configured to accommodate extension of the anisotropic mechanism parallel to the longitudinal centerline, and wherein the anisotropic mechanisms combine to transmit a torque along the longitudinal centerline.

2. The drive shaft member of claim 1, wherein the anisotropic mechanisms comprise compliant mechanisms.

3. The drive shaft member of claim 2, wherein each of the compliant mechanisms is configured to approximate a straight line mechanism (SLM) configured to constrain a point in the SLM to move substantially parallel to the longitudinal centerline.

4. The drive shaft member of claim 3, wherein each of one or more of the compliant mechanisms is configured to approximate a Watt's mechanism, a Robert's mechanism, a Double 4-Bar mechanism, a Lambda mechanism, or a Peaucellier-Lipkin mechanism.

5. (canceled)

6. (canceled)

7. (canceled)

8. The drive shaft member of claim 2, comprising a monolithic structure comprising the compliant mechanisms, wherein the monolithic structure has a constant thickness perpendicular to the longitudinal centerline.

9. (canceled)

10. (canceled)

11. The drive shaft member of claim 1, comprising annular rings, wherein each of the annular rings is formed from a respective subset of the anisotropic mechanisms.

12. The drive shaft member of claim 1, wherein the anisotropic mechanisms are arranged to approximate a cylinder.

13. The drive shaft member of claim 1, comprising flat panel portions that extend parallel to the longitudinal centerline, wherein each flat panel portion comprises a respective subset of the anisotropic mechanisms, and wherein the drive shaft member has a cross section with a polygonal exterior perimeter.

14. The drive shaft member of claim 13, comprising attachment members via which the flat panel portions are connected.

15. (canceled)

16. (canceled)

17. (canceled)

18. The drive shaft member of claim 1, wherein the anisotropic mechanisms are arranged in a pattern comprising mirror symmetries and/or rotational symmetries.

19. A drive shaft assembly comprising:
a first drive shaft member comprising first anisotropic mechanisms that are interconnected and distributed circumferentially around a longitudinal centerline of the drive shaft assembly, wherein each of the first anisotropic mechanisms is configured to accommodate extension of the first anisotropic mechanism parallel to the longitudinal centerline, and wherein the first anisotropic mechanisms are configured to combine to transmit a first torque along the longitudinal centerline; and
a second drive shaft member concentric with the first drive shaft member and extending through the first drive shaft member, wherein the second drive shaft member comprises second anisotropic mechanisms that are interconnected and distributed circumferentially around the longitudinal centerline, wherein each of the second anisotropic mechanisms is configured to accommodate extension of the second anisotropic mechanism parallel to the longitudinal centerline, and wherein the second anisotropic mechanisms are configured to combine to transmit a second torque along the longitudinal centerline independent of the first torque.

20. The drive shaft assembly of claim 19, further comprising one or more bearings configured to separate the first drive shaft member and the second drive shaft member and accommodate relative rotation between the first drive shaft member and the second drive shaft member.

21. (canceled)

22. (canceled)

23. The drive shaft assembly of claim 19, wherein each of the first anisotropic mechanisms and the second anisotropic mechanisms comprises compliant mechanisms.

24. The drive shaft assembly of claim 23, wherein each of the compliant mechanisms is configured to approximate a straight line mechanism (SLM) configured to constrain a point in the SLM to move substantially parallel to the longitudinal centerline.

25. The drive shaft assembly of claim 24, wherein each of one or more of the compliant mechanisms is configured to approximate a Watt's mechanism, a Robert's mechanism, a Double 4-Bar mechanism, a Lambda mechanism, or a Peaucellier-Lipkin mechanism.

26. (canceled)

27. The drive shaft assembly of claim 23, wherein each of the compliant mechanisms is monolithic.

28. (canceled)

29. The drive shaft assembly of claim 23, comprising a first monolithic structure and a second monolithic structure, wherein the first monolithic structure comprises a first set of the compliant mechanisms, wherein the second monolithic structure comprises a second set of the compliant mechanisms, and wherein at least one of the first monolithic structure and the second monolithic structure has a constant thickness perpendicular to the longitudinal centerline.

30. (canceled)

31. (canceled)

32. The drive shaft assembly of claim 19, wherein:
the first drive shaft member comprises first drive shaft member annular rings;
each of the first drive shaft member annular rings is formed from a respective subset of the first anisotropic mechanisms;
the second drive shaft member comprises second drive shaft member annular rings; and
each of the second drive shaft member annular rings is formed from a respective subset of the second anisotropic mechanisms.

33. The drive shaft assembly of claim 19, wherein:
the first anisotropic mechanisms are arranged to approximate a first cylinder; and
the second anisotropic mechanisms are arranged to approximate a second cylinder.

34. (canceled)

35. (canceled)

36. (canceled)

37. The drive shaft assembly of claim 19, wherein at least one of the first anisotropic mechanisms and the second anisotropic mechanisms are arranged in a pattern comprising mirror symmetries and/or rotational symmetries.
